(19) United States
(12) Patent Application Publication
(10) Pub. No.: US 2011/0016828 A1
(43) Pub. Date: Jan. 27, 2011

(54) Method And Apparatus For Labeling A Cap And Threading The Cap Onto A Bottle

(76) Inventors: Richard A. Parker, Portage, IN (US); George E. Ervin, Valparaiso, IN (US); William J. Connelly, Portage, IN (US); Daniel R. Perkins, LaPorte, IN (US); Oscar O. Medina, Hammond, IN (US); Kerry T. McColly, LaPorte, IN (US)

Correspondence Address: WOMBLE CARLYLE SANDRIDGE & RICE, PLLC, ATTN: IP DOCKETING, P.O. BOX 7037, ATLANTA, GA, 30357-0037, US

(21) Appl. No.: 12/842,504

(22) Filed: Jul. 23, 2010

Related U.S. Application Data
(60) Provisional application No. 61/271,617, filed on Jul. 23, 2009.

(51) Int. Cl. B65B 61/00; B67B 3/20

(52) U.S. Cl. 53/415; 53/490; 53/135.1; 53/317

(57) ABSTRACT

Methods and apparatus are disclosed for processing a plastic container by applying a label to a cap, threading the cap on a bottle, and closing dispensing doors on the cap before a heat shrink label sleeve is applied. The label is applied to the cap in a predetermined orientation with respect to the cap and the cap is threaded onto the bottle by a threader wheel adjacent a starwheel that carries caps and bottles in alignment. The dispenser door is closed by a peg that is urged downwardly into contact with the dispenser door.

### REFERENCE TO RELATED APPLICATION

This application claims the benefit of U.S. Provisional Application No. 61/271,617, which was filed on Jul. 23, 2009.

### INCORPORATION BY REFERENCE

U.S. Provisional Application No. 61/271,617, which was filed on Jul. 23, 2009, is hereby incorporated by reference for all purposes as if presented herein in its entirety.

### TECHNICAL FIELD

This provisional disclosure relates generally to containers with screw-on caps and more specifically to automated equipment for applying an aligned label to the caps and threading the labeled caps onto their bottles.

### BACKGROUND

Plastic containers, such as the Wrigley® BigEpak™ bulk chewing gum container, are becoming more prevalent. Such containers often have a plastic bottle sized to contain a certain volume of product (e.g. 60 pieces of chewing gum) and a screw-on plastic cap. In the case of the BigEpak container, the plastic cap is asymmetrical in that it has a top surface that slopes upwardly from a relatively thin side of the cap to a relatively thick side of the cap. A small dispensing door is located on the rim of the cap at the thick side for dispensing individual pieces of gum from the container. A large dispensing door is formed in the top surface of the cap and can be snapped open to dispense larger quantities of gum from the container. The doors are configured to be popped open so that chewing gum pieces can be shaken into a user's hand, whereupon they can be snapped shut. A label applied by a packaging machine to the surfaces of caps must apply a label to each of perhaps thousands of caps so that each label is aligned in a specified way with respect to the dispensing doors of its cap. This is because, among other things, the label may include pointers to the dispensing doors with instructions such as “open,” or a manufacturer may simply want the label always to be displayed in a certain orientation.

Filling such containers, applying aligned labels to their caps, threading on the caps, and applying a graphic sleeve, which also must be properly aligned with respect to the cap, presents certain challenges for high speed bottling or packaging equipment. For example, the caps must each be properly oriented before a label is applied, the asymmetrical caps must be threaded onto the tops of bottles, which may not be cylindrical, and the dispensing doors of the caps must be securely closed before a graphic sleeve is applied and shrunk around the container. A need exists for automated production apparatus capable of accomplishing these and other tasks at relatively high throughput rates, effectively, efficiently, and at a reasonable cost. It is to the provision of such an apparatus and a method of filling, closing, and labeling such containers that the present invention is primarily directed.

### SUMMARY

The entire contents of U.S. provisional patent application 61/271,617, to which priority is claimed above, is hereby incorporated fully by reference.

Briefly described, an apparatus and method are disclosed for applying aligned labels to the tops of screw-on caps, threading the caps on the tops of respective plastic bottles, and insuring that the dispensing doors of the cap are securely closed prior to application of a graphic sleeve to the container. The caps are delivered one-at-a-time to a single file chute from a vibratory bowl. A rail or rails are disposed above the caps on the chute to orient the caps properly and prevent them from rotating. The oriented caps are released from the rails just before a label is applied by a labeling device so that the caps stay oriented with respect to the applied labels.

The labeled caps are then conveyed to a threader apparatus, where the caps are brought by a star wheel arrangement into alignment with their bottles. Downward pressure is applied to each cap by a flexible bellows as the cap moves around a starwheel while the cap passes and contacts a spinning threader wheel, which causes the cap to rotate and thread onto its bottle. Finally, the capped bottles are conveyed to an orienter, which is configured to orient the capped bottles in the same direction before they move to a sleeve applicator, which applies a graphic sleeve around the bottle. While traversing the orienter, pins are extended downwardly to engage and close the dispensing doors of the caps to insure that moisture does not enter the container in a subsequent steam bath used for shrinking the graphic sleeves.

Thus, a method and apparatus has been invented for applying aligned cap labels, threading caps onto bottles, and closing dispensing doors in caps that is efficient, effective, and capable of achieving throughput required for high speed production. These and other features, aspects, and advantages will be better understood upon review of the detailed description set forth below when taken in conjunction with the accompanying drawing figures, which are briefly described as follows.

### BRIEF DESCRIPTION OF THE DRAWINGS

FIGS. 1 and 2 illustrate an example container with screw-on cap and dispensing doors that may be filled, closed, and labeled according to the present disclosure.

FIG. 3 is a perspective view of a portion of an apparatus for applying screw-on caps to containers such as those shown in FIGS. 1 and 2 according to the disclosure.

FIG. 4 is a perspective view of a portion of an apparatus for closing the dispenser doors of containers such as those shown in FIGS. 1 and 2.

FIG. 5 is a perspective view of a portion of a cap labeling apparatus from the rear side illustrating the use of rails over the caps to align the caps for label application.

FIG. 6 is a perspective view illustrating a line of aligned caps just before the lead cap is released onto the labeling machine conveyor.

FIG. 7 is a perspective view of a portion of a cap labeling apparatus for applying aligned labels to caps according to the disclosure.

FIG. 8 is a perspective view illustrating labeled caps being conveyed and delivered to the star wheel of the apparatus for applying the caps to bottles, also shown in FIG. 3.

### DETAILED DESCRIPTION

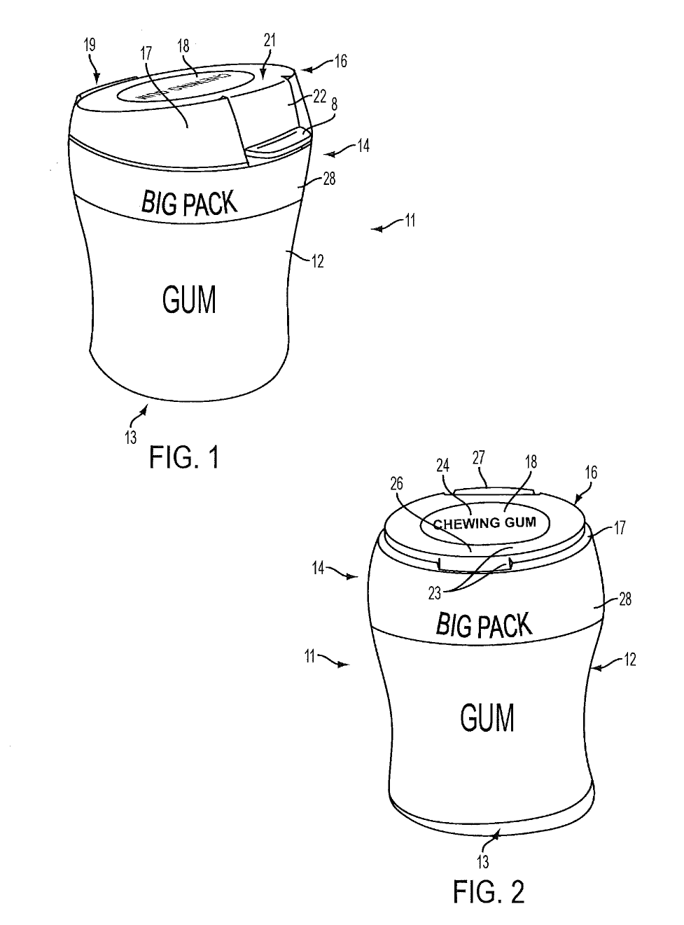

Reference will now be made to the annexed drawing figures, wherein like reference numerals indicate like parts throughout the several views. FIGS. 1 and 2 illustrate a plastic container in the form of a chewing gum dispenser with which the method and apparatus of this disclosure may be used. The invention will be described and illustrated within the context of this container; however, the invention is not limited to this particular container and may be applied to many other configurations of containers. Referring to FIGS. 1 and 2, which show the container from different perspectives, the container 11 comprises a plastic bottle 12 configured to contain product such as chewing gum pieces. The bottle 12 has a bottom end portion 13 and a top end portion 14, which is formed with external threads (not visible). A plastic cap 16 has internal threads and is screwed onto the top end portion of the bottle 12. The cap 16 is asymmetrical in that its top surface 18 is angled upwardly from a thinner side 19 of the cap to a thicker side 21 of the cap.

A small dispensing door 22 is disposed on the rim of the cap at its thicker side for dispensing individual pieces of gum and a much larger dispensing door 23 is formed in the top surface 18 of the cap and, when hinged upwardly, opens up the majority of the area of the upper surface for dispensing larger quantities of gum from the container. A label 24 is applied to the top surface 18 of the cap substantially covering the larger dispensing door and the label is aligned with the cap in the sense that its graphics are oriented substantially transverse relative to a line between the thinner side and the thicker side of the cap. In this way, the graphics on each cap is oriented the same way, and also is aligned in a desired way with the graphic sleeve 28 surrounding the bottle. In some cases, the label 24 may have instructional indicia such as an arrow and the word “open” that must be aligned with the thumb tabs of the small and large dispensing doors, as generally indicated at 26 and 27.

Applying the label 24 to the cap in an aligned orientation, threading the cap 16 onto the bottle 12, and insuring that the dispensing doors 22 and 23 and securely snapped shut before the heat-shrink label 28 is applied to the bottle present certain manufacturing challenges due, at least in part, to the asymmetrical shape of the cap and the non-cylindrical shape of the bottle. The present invention is directed to apparatus and methods for addressing these challenges to accomplish these tasks in an efficient manner and at the speeds necessary for a desired product throughput.

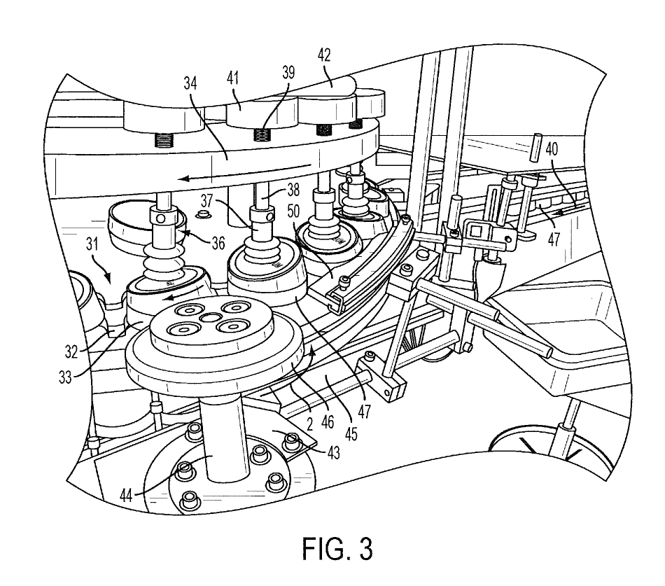

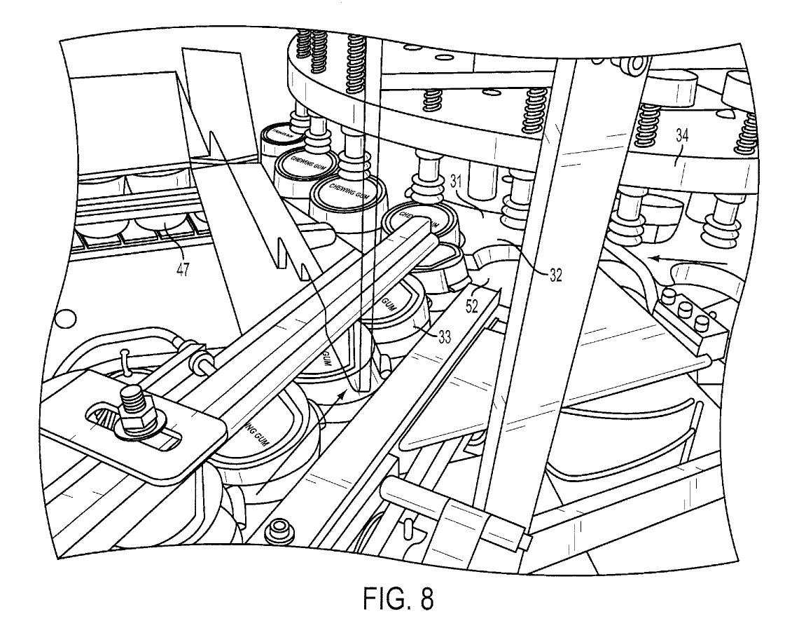

FIGS. 3 and 8 illustrates a threading apparatus and method for threading the caps of FIGS. 1 and 2, with their aligned labels already applied, onto respective bottles. The bottles 47, which, in production, are filled with product, are conveyed in single file to the threading apparatus as indicated by arrow 40. Caps 33 with their labels applied also are conveyed in single file to the threading apparatus at a location ahead of the location where the bottles enter the threading apparatus (See FIG. 8). The threading apparatus includes a starwheel 31 having a plurality of generally circular bays 32 formed about its periphery. An upper disc 34 is mounted above the starwheel and rotates therewith. The upper disc 34 carries an array of hold-down assemblies 36 that are generally aligned above respective ones of the starwheel bays 32. Each hold-down assembly comprises a shaft 38 that extends through a hole in the upper disc and is biased upwardly by a spring 39. A flexible rubber bellows 37 is mounted to the bottom end of each shaft 38 and a cam roller 41 is rotatably secured to the top end of each shaft. A cam rail 42 is disposed above the upper disc 34 and is configured to force the hold-down assemblies downwardly at the appropriate time for applying downward pressure to the caps atop their bottles, as detailed below.

A threader 43 is mounted adjacent the starwheel and includes a rotatable shaft 44 to the top of which is mounted a threader wheel 46. The threader wheel 46 is fabricated of a resilient material such as rubber or foam so that it can press against and conform to the rims of the caps 33 with a friction sufficient to spin the caps as the threader wheel rotates. A bumper 50 is provided adjacent the bays of the starwheel to insure that the caps remain properly positioned atop their bottles as they approach the threader 43.

In operation, the starwheel and upper disc are rotated by a drive chain (not shown) in a clockwise direction as seen from the top as indicated by the arrow. Caps 33 are conveyed as illustrated in FIG. 8 to the threading apparatus in single file such that one cap is captured in each of the bays 32 of the starwheel and is supported atop a plate 52. The rotating starwheel carries the caps around the apparatus until they meet up and align with corresponding bottles 47 as the bottles enter the threading apparatus, whereupon the caps sit loosely atop their corresponding bottles. This configuration is shown to the left of the threader assembly 43 in FIG. 8. At or about the point where a cap meets up with its bottle, the hold-down assembly above the cap is forced downwardly until its flexible bellows engages and applies downward pressure to the cap. More specifically, the cam roller 41 of the hold-down assembly is engaged by the cam rail 42, which is angled and configured to force the cam roller and its hold-down assembly downwardly a predetermined distance against the bias of spring 39 until the bellows engages the cap. Since the bellows is flexible, its end naturally angles as it engages the cap to conform to the angled top surface of the cap, thereby applying balanced downward force. This keeps the cap positioned atop its bottle before it is threaded thereon. The bumper 50 provides a guide that also helps hold and position the caps in their bays atop their respective bottles as the caps and bottles approach the threader 43 (FIG. 3).

The threader is rotated by a drive mechanism (not shown) in a counterclockwise direction as indicated by arrow 45. As each bottle and cap approaches the threader 43, the threader wheel 46 engages the rim of the cap and, because of the resilient nature of the wheel, conforms at least partially to the circular shape of the rim and, due to the friction between the threader wheel and the cap, forces the cap to spin atop its bottle in a clockwise direction. This, in conjunction with the downward pressure applied by the bellows of the hold-down assembly, causes the cap to thread onto the bottle to enclose the contents of the bottle such as, for instance, chewing gum. The bottles may subsequently pass through a snugger (not shown), which gives each cap a final twist with a predetermined torque to insure that is properly seated on its bottle.

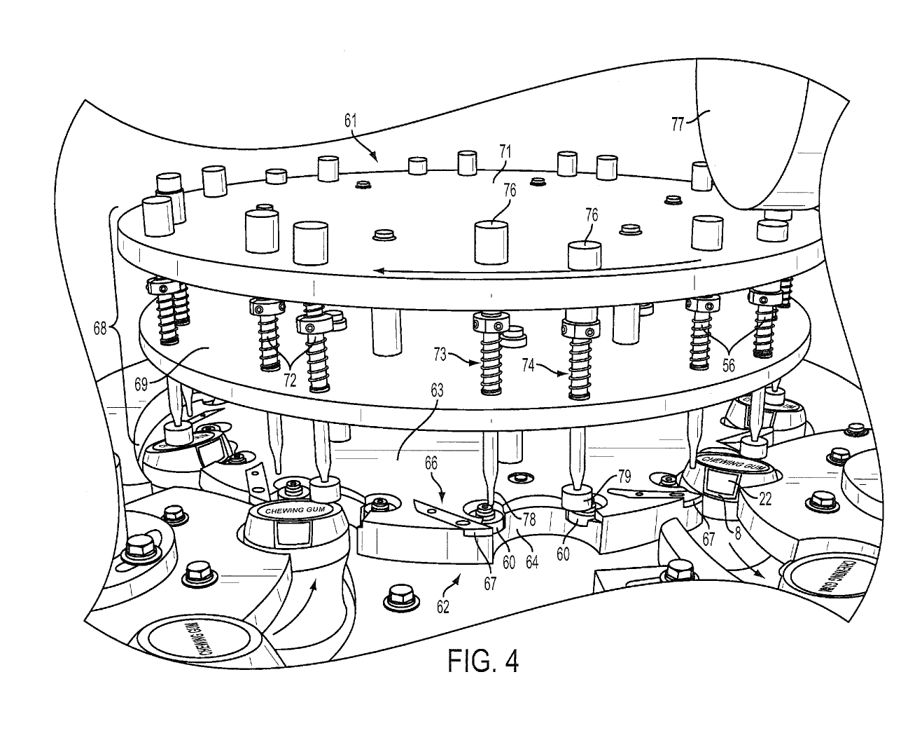

After the caps are threaded onto the bottles, the bottles are wrapped with a heat shrinkable sleeve bearing logos and graphics associated with the product inside. The sleeve also must be aligned on the bottle with respect to the cap and its label so that each container has graphics in the same position around the container. However, before application of the heat shrinkable sleeve, it must be insured that the small dispensing door and the large dispensing door are snapped securely shut. FIG. 4 illustrates a container orienter and door closing assembly for accomplishing these tasks. The orienter 62 comprises a starwheel 63 that is rotated in a clockwise direction as seen from the top. The starwheel 63 is provided with an array of bays 64 about its periphery sized to receive the upper portions of previously capped containers as shown. A pawl assembly 66 is associated with each bay of the starwheel and includes a pawl 67 that projects a short distance into the interior of the bay. As the containers are delivered to the bays of the starwheel from the left in FIG. 4, they are carried around the starwheel, where they rotate in a clockwise direction within their bays, aided by rollers 60. As they rotate, the thumb tab 8 of the small dispensing door 22 (see FIG. 1) eventually rotates into contact with the pawl 67 of the bay (to the right in FIG. 4), which stops the rotation of the container at a predetermined orientation. The oriented containers are then conveyed in their properly oriented positions to a sleeve applicator (not shown) for application of a heat-shrink graphics sleeve, after which they pass through a steam bath or other heating mechanism to shrink the sleeve around the bottle. Thus, each bottle is oriented with its threaded-on cap oriented in precisely the same direction as a graphics sleeve is applied. In this way, the graphics sleeve of each bottle is properly oriented with respect to the cap and the graphic sleeves of all bottles are oriented in the same way.

As mentioned, it must be insured that the dispensing doors 22 and 23 are securely snapped shut before the containers pass through the sleeve applicator and stem bath. To accomplish this, a door closer assembly 68 (FIG. 4) is integrated with the orienter 62 to snap the dispenser doors shut before they leave the orienter. The door closer assembly comprises a lower disc 69 and an upper disc 71 that are spaced from each other and rotate together in unison with the orienter starwheel 63. The discs 69 and 71 carry an array of closing pin assemblies 72, each of which includes a leading closing pin 73 and a trailing closing pin 74. Each closing pin extends slidably through the lower disc 69 to a bottom end and is spring biased to a raised position by springs 56. The bottom end 78 of the leading pin 73 is bare while a cushion pad 79 is provided on the bottom end of the trailing pin 74. A peg 76 is secured to the top of each pin and projects through a corresponding hole formed in the upper disc 71.

A roller 77 is disposed atop the upper disc 71 at its periphery and rotates about an axis transverse to the axis of rotation of the disc 71. The roller 77 is sized and positioned to engage and press down on the pegs 76 of the pins 73 and 74 as the pegs pass beneath the roller. This, in turn, forces the pins downwardly against the bias of their springs and allows them to pop up again after they move past the roller 77. As shown on the right hand side of FIG. 4, as the caps of the oriented containers move about the starwheel, the leading pin is first pressed downwardly by the roller 77 until its end 78 engages the smaller dispensing door 22 in such a way that the door is closed and snapped securely shut by the end of the pin. Shortly after the leading pin begins its downward movement, the peg of the trailing pin is engaged by the roller 77 and it is progressively pressed downwardly until its cushioned pad 79 engages the larger dispensing door in the top surface of the cap in such a way that the larger dispensing door is closed and snapped securely shut. With the dispensing doors secured and the containers properly oriented, they leave the orienter star wheel and are conveyed to the sleeve applicator for application of an aligned heat-shrink sleeve in a known manner.

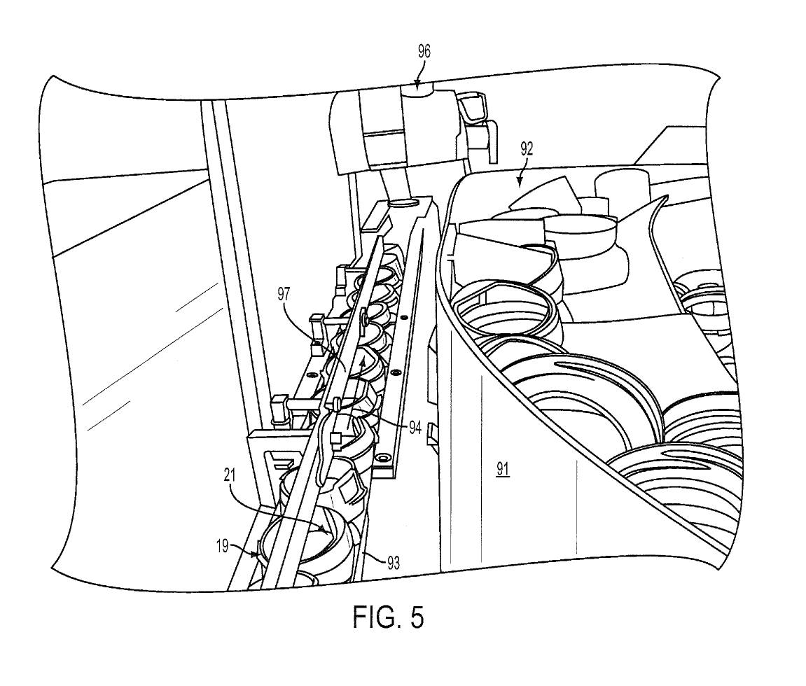

As previously mentioned, before the caps are threaded onto their bottles, a label is applied in a predetermined alignment to the top surfaces of the caps covering the larger dispensing door formed therein. FIGS. 5-7 illustrate an apparatus and method of applying labels to the caps so that the labels are properly aligned. Referring to FIG. 5, a vibratory hopper or bowl 91 contains large numbers of unlabeled caps 92 from a cap manufacturer. As is known in the art, the vibratory bowl functions to deliver the caps one-at-a-time to a chute 93. The caps are pushed along the chute 93 in direction 94 toward a labeling machine 96, which is configured to apply a label to the top surface of each cap. According to the invention, an alignment rail 97 is mounted above and extends along the length of the chute 93 overlying the caps moving therealong. The location of the lower surface of the alignment rail 97 is slightly above the mid portion of the tops of the caps; that is, the portion of the cap tops between the thicker end 21 and the thinner end 19. This arrangement takes advantage of the angled top surface of the caps to cause the caps to remain oriented in the same direction as they move along the chute. More specifically, the alignment bar overlies closely the intermediate portion of each cap top in such a way that the cap is prevented from spinning and thus stays aligned in the general orientation shown in FIG. 5. Thus, as each cap approaches the labeler 96, it is appropriately aligned for application of a label in the desired alignment with respect to the cap top.

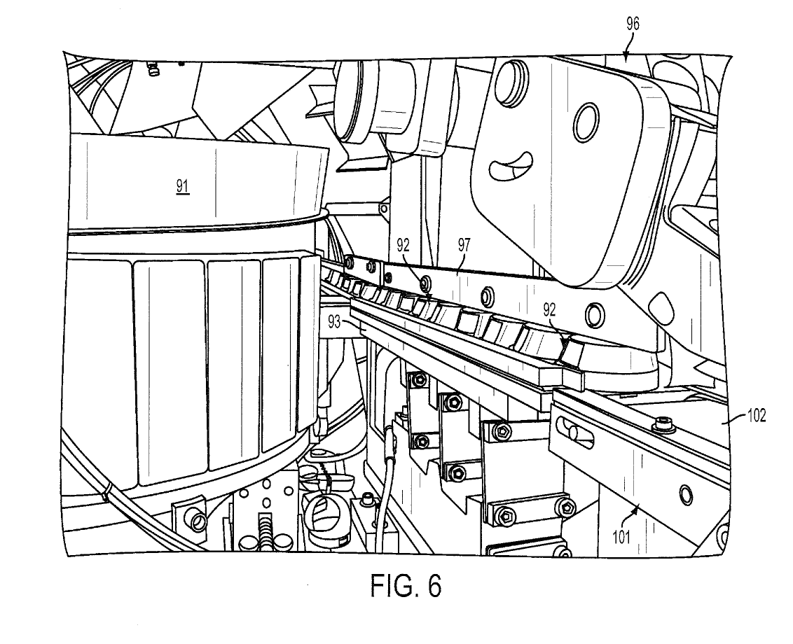

FIG. 6 is a view from the downstream end of the chute 93 showing a plurality of caps 92 moving along the chute with the leading cap approaching the labeling station of the labeler 96. It can be seen that the alignment bar 97 in conjunction with the side walls of the chute 93 have aligned the caps with their smaller dispensing doors 22 all facing in the same direction, i.e. facing left in FIG. 6. Thus, as the leading cap moves to the right out of the chute 93 and onto the a conveyor belt 102 of conveyor 101, it remains aligned in substantially the same orientation it was in when it left the chute 93. The conveyor belt 102 carries each cap immediately to the labeling station of labeler 96 so that a cap label is applied before the cap can become misaligned by vibrations, friction, or other factors.

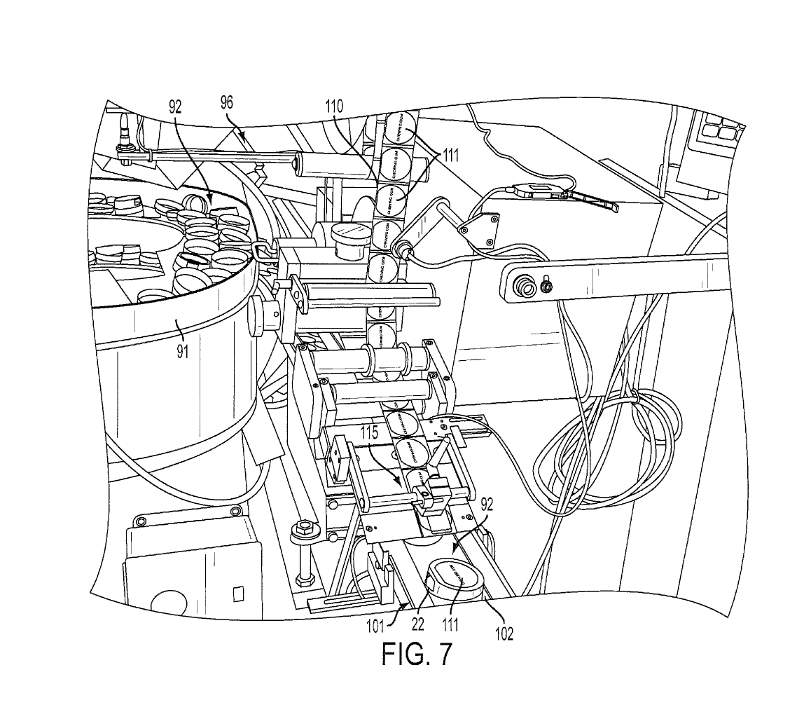

FIG. 7 illustrates labels being applied to the top surfaces of the caps 92 as they are conveyed along the conveyor 101 immediately after leaving the chute 93. As can be seen, the caps remain aligned on the conveyor belt 102 in substantially the same orientation as they left the chute. The labeler 96 is standard and includes mechanisms for conveying a web 110 containing labels 111 from a roll (not shown) to a labeling station generally indicated at 115. The labeling station is configured and timed to apply a single label 111 to the top surface of each cap as the cap passes beneath the labeling station, as is known in the art. It can be seen that in this case, however, all of the labels 111 are oriented in the same direction on the web 110, specifically with their graphics oriented along the direction of movement of the web. Thus, since each cap is aligned with its smaller dispensing door 22 and its thicker side oriented to the left in FIG. 1, each label is applied and aligned in substantially the same orientation with respect to the dispensing doors of the cap, as is desired. With the aligned labels applied to the caps, the caps can be conveyed to the threading assembly, as illustrated in FIGS. 3 and 8, for threading onto respective bottles as described in detail above.

The invention has been described herein in terms of preferred embodiments and methodologies considered by the inventors to represent the best mode of carrying out the inventions disclosed herein. It will be understood by those of skill in the art, however, that a wide variety of additions, deletions, and modifications might well be made to the illustrated embodiments without departing from the spirit and scope of the invention. For example, in the preferred embodiment of the threader, the cap is contacted by the threader wheel to spin the cap onto the bottle. Alternatively, the bottle may be contacted with a threader wheel to spin the bottle with the cap held stationary to obtain the same result in an equivalent manner. The particular container depicted in the preferred embodiment is not limiting, nor is its asymmetrical top. The invention is applicable to virtually any container wherein labels are to be applied in a predetermined orientation. These and other additions, deletions, and modifications, both subtle and gross, might well be made by the skilled artisan without departing from the spirit and scope of the invention. Thus, the invention is broader than the preferred and illustrated embodiments and should not be circumscribed thereby.

What is claimed is:

1. A method of labeling a cap and threading the cap onto a bottle comprising the steps of:
(a) moving a plurality of caps progressively in a downstream direction;
(b) aligning the caps in a predetermined common orientation as they move in the downstream direction;
(c) applying a label to each cap while the cap is aligned in the common orientation so that the applied labels are oriented in substantially the same direction on each of the plurality of caps;
(d) moving the labeled caps progressively atop corresponding bottles;
(e) progressively treading each cap onto its corresponding bottle;
(f) aligning the capped bottles in a predetermined common orientation; and
(g) applying labels to the bottles while the bottles are aligned in the common orientation so that the labels are applied to the bottles in substantially common alignment with the labels on the caps.

2. The method of claim 1 and wherein step (a) comprises moving the plurality of caps in single file in the downstream direction.

3. The method of claim 2 and wherein the caps have a relatively thinner side and a relatively thicker side opposite the thinner side and wherein step (b) comprises engaging the caps between their thinner and thicker sides with an alignment bar.

4. The method of claim 3 and wherein step (c) comprises moving the caps through a labeling station configured to apply labels to the aligned caps.

5. The method of claim 1 and wherein step (d) comprises moving the caps in single file toward a capping station, moving bottles in single file toward a capping station, and positioning each cap atop a corresponding bottle at the capping station.

6. The method of claim 5 and wherein the step of positioning each cap comprises moving each bottle into a bay of a starwheel and moving each cap into a bay of a starwheel overlying a corresponding bottle.

7. The method of claim 1 and wherein step (e) comprises spinning each bottle and its corresponding cap with respect to each other while urging the bottle and cap toward each other.

8. The method of claim 7 and wherein the step of spinning comprises rotating the cap.

9. The method of claim 8 and wherein the rotating step comprises engaging the periphery of each cap with a spinning wheel.

10. The method of claim 7 and wherein the urging step comprises applying pressure to the top of each cap.

11. The method of claim 10 and wherein the step of applying pressure comprises moving a flexible bellows into contact with the top of each cap.

12. The method of claim 1 and wherein step (f) comprises rotating each capped bottle until a projection on the cap of each bottle engages a pawl.

13. The method of claim 12 and wherein the rotating step comprises moving each capped bottle into a bay of a starwheel having pawls projecting partially into the bays and rotating each capped bottle until the projection on the cap engages the pawl.

14. The method of claim 12 and wherein each cap has a dispensing door and wherein the projection is formed on the dispensing door.

15. The method of claim 1 and wherein step (g) comprises applying heat-shrinkable sleeve around each bottle and exposing the sleeve to heat to cause it to shrink around the bottle.

16. The method of claim 1 and wherein each cap has a dispensing door and further comprising the step of closing the dispensing door prior to step (f).

17. The method of claim 16 and further comprising moving a peg into contact with the dispensing door to close the door and retracting the peg.

18. An apparatus for applying labels to caps in a predetermined orientation, threading the caps onto bottles, and applying labels to the bottles in alignment with the labels on the caps, the apparatus comprising:
a hopper for containing a supply of caps;
a chute configured to receive caps from the hopper and arrange the caps in single file with the caps moving in a downstream direction along the chute,
an alignment mechanism associated with the chute for aligning the caps in a common predetermined orientation as the caps move along the chute;
a labeler adjacent a downstream end of the chute configured to apply a label to each commonly oriented cap;
a threading assembly for treading each labeled cap onto a corresponding bottle;
an orienting assembly for rotating each of the capped bottles to a common orientation; and
a bottle labeler for applying labels to the bottles in predetermined alignment with the labels on the caps of the bottles.

19. The apparatus of claim 18 and wherein the caps have a relatively thin side and a relatively thick side opposite the thin side, the alignment mechanism comprising an alignment bar disposed over a central portion of the chute at a height intermediate the thickness of the relatively thin side and the relatively thick side of the caps, the alignment bar engaging the caps intermediate their relatively thick and relatively thin sides to orient the caps in a common orientation as they move along the chute.

20. The apparatus of claim 18 and further comprising a conveyor having an upstream end adjacent a downstream end of the chute such that caps move from the chute onto the conveyor, the labeler applying a label to each cap at the upstream end of the conveyor while the cap remains substantially in its common orientation.

21. The apparatus of claim 18 and wherein the treading assembly comprises a rotating starwheel having peripheral bays for receiving caps and at least the upper portions of bottles, a supply of bottles moving into the threading assembly with their top portions disposed in the bays and a supply of labeled caps moving into the bays aligned atop corresponding bottles, and a threader for rotating the bottles and caps with respect to each other to thread the caps onto the bottles.

22. The apparatus of claim 21 and wherein the threader comprises a rotating wheel adjacent the starwheel and positioned to engage a peripheral edge of each cap to rotate the cap with respect to the underlying bottle.

23. The apparatus of claim 22 and wherein the treading assembly further comprises a hold down mechanism for urging each cap and bottle toward one another as the cap is threaded onto the bottle.

24. The apparatus of claim 23 and wherein the hold down mechanism comprises a flexible bellows overlying each bay of the starwheel secured to the end of a vertically movable shaft and a cam rail positioned to move each shaft downwardly to engage a cap in the corresponding bay with the flexible bellows to urge the cap toward the bottle as the cap is threaded onto the bottle.

25. The apparatus of claim 18 and wherein the orienting assembly comprises a starwheel having a plurality of peripheral bays for receiving capped bottles, at least one rotating wheel associated with each bay for rotating a bottle disposed within the bay, and a pawl extending partially into each bay, the pawl positioned to engage a projection on the cap of each bottle to halt rotation of the bottle within its bay when the cap reaches the predetermined orientation.

26. The apparatus of claim 25 and wherein the caps comprise dispensing doors and wherein the projection of each cap is located on its dispensing door.

27. The apparatus of claim 18 and wherein the caps comprise closable dispensing doors and further comprising a door closing assembly for insuring that the dispensing doors of the bottles are closed.

28. The apparatus of claim 27 and wherein the orienting assembly comprises a plurality of bays within which capped bottles are rotated and oriented in their common orientations and wherein the door closing assembly is located above the orienting assembly and comprises at least one peg disposed above each bay of the orienting assembly, each peg being aligned with the dispensing door of a bottle in the underlying bay when the bottle is in its common orientation, and means for moving each peg toward and into engagement with the dispensing door to shut and secure the dispensing door.

29. The apparatus of claim 28 and wherein the pegs extend through a plate above the orienting assembly and are biased to a retracted position, and wherein the means for moving comprises a surface that engages a top portion of each peg to move the biased peg into engagement with the dispensing door.

30. The apparatus of claim 29 and wherein the surface comprises the periphery of a roller.
